(19) United States
(12) Patent Application Publication
(10) Pub. No.: US 2021/0305720 A1
(43) Pub. Date: Sep. 30, 2021

(54) WIRELESS SYSTEM ON FLEXIBLE SUBSTRATE

(71) Applicant: University of Massachusetts, Boston, MA (US)

(72) Inventors: Hualiang Zhang, Arlington, MA (US); Bowen Zheng, Dracut, MA (US); Hong Tang, Lowell, MA (US)

(21) Appl. No.: 17/216,042

(22) Filed: Mar. 29, 2021

Related U.S. Application Data
(60) Provisional application No. 63/002,517, filed on Mar. 31, 2020.

(51) Int. Cl. H01Q 21/06; G01S 7/03; H01Q 1/38; H01Q 17/00

(52) U.S. Cl. CPC H01Q 21/065; H01Q 17/008; H01Q 1/38; G01S 7/032

(57) ABSTRACT

A wireless system includes an apparatus comprising: a flexible substrate; a radar sensor device disposed on the flexible substrate; and an electrically conductive path communicatively coupled to the radar sensor device. The apparatus further includes one or more integrated circuit chips (components such as semiconductor devices) connected to the radar sensor device; the circuit chips provide radar sensor functionalities. The integrated circuit chips are in contact with (such as disposed on) the flexible substrate and/or the electrically conductive circuit paths. The flexible radar system generates and receives wireless signals during conditions in which the circuitry disposed on the flexible substrate is bent to one or more non-planar states.

### RELATED APPLICATION

This application claims the benefit of earlier filed U.S. Patent Application Ser. No. 63/002,517 entitled “REGISTRATION OF DEVICES FOR USE OF ONE OR MORE SERVICES,” filed on Mar. 31, 2020, the entire teachings of which are incorporated herein by this reference.

### BACKGROUND

With the vastly developed market for health monitoring, autonomous driving, and wearable devices, a key limitation to wireless system is the integration of complex radar sensors. The most common and traditional approach in a radar system is to use rigid PCB (Printed Circuit Board) substrates, such as FR4 substrates to implement the sensors and their driving modules.

### BRIEF DESCRIPTION OF EMBODIMENTS

Conventional radar systems suffer from deficiencies. For example, conventional radar systems are typically disposed on rigid substrates. This makes it difficult to implement in different shaped objects. It is further noted that rigid substrates are heavy, which dramatically impacts the final product in which the radar system is installed.

Embodiments herein include novel architectures supporting wireless communications. For example, one embodiment herein includes an apparatus comprising: a flexible substrate; a radar sensor device disposed on the flexible substrate; and an electrically conductive path communicatively coupled to the radar sensor device. The apparatus further includes one or more integrated circuit chips (components such as semiconductor devices) connected to the radar sensor device; the circuit chips provide radar sensor functionalities. In one embodiment, the integrated circuit chips are in contact with (such as disposed on) the flexible substrate and/or the electrically conductive circuit paths. During operation, the radar sensor device generates and receives wireless signals during conditions in which the radar sensor device disposed on the flexible substrate is bent to one or more different non-planar states.

Thus, in one embodiment, the flexible radar sensor device as described herein may initially be operated in a planar state. However, the radar sensor device disposed on the flexible substrate is susceptible to being bent to any nonplanar state. Regardless of whether the flexible substrate and corresponding radar sensor device are operated in a bent non-planar state or a non-bent planar state, the radar sensor device generates and receives wireless signals.

In further example embodiments, the radar sensor device as discussed herein includes a patch antenna array with multiple patches interconnected via one or more electrically conductive paths. Dimensions and fabrication of the electrically conductive paths, antenna elements, etc., associated with the radar sensor device facilitate operation of the radar sensor device and corresponding antenna elements in the non-planar state. In further example embodiments, the flexible substrate is fabricated to include more rigid non-bending portions (first regions) that generally do not bend (or bend less) and less rigid bending portions (second regions) that bend along respective bending lines.

Still further example embodiments include an antenna interface affixed to the flexible substrate. The antenna interface is operative to receive and transmit signals over the electrically conductive path.

Further embodiments herein include a method comprising: generating a model of a flexible substrate and corresponding radar sensor device disposed on the flexible substrate; analyzing operation of the corresponding radar sensor device (such as antenna hardware) during different bend states of the flexible substrate in which the flexible substrate is bent to different non-planar states; and deriving dimensions of an electrically conductive path (such as a transmission line, energy feeding network, etc.) on the flexible substrate based on the operation of the model during different states.

In one embodiment, the electrically conductive path is a transmission line that drives antenna hardware disposed on the flexible substrate. The method as discussed herein includes selecting dimensions of the transmission line (for a range of different possible flexible substrate bend states) such that the impedance of the transmission line (during different bend conditions) is substantially matched to the corresponding antenna hardware. In further example embodiments, the antenna hardware disposed on the substrate is flexible as well.

Still further example embodiments herein include deriving the dimensions of the electrically conductive path (such as transmission line) via controlling dimensions of the electrically conductive path to account for bending of the flexible substrate to the different possible non-planar states of the flexible antenna hardware.

As previously discussed, deriving the dimensions of the electrically conductive path can include adjusting an impedance of the electrically conductive path (transmission line) so that the impedance of the transmission line is matched to the flexible antenna hardware for the different possible bend states.

The antenna hardware disposed on the flexible substrate can be implemented in any suitable manner. For example, in one embodiment, the radar sensor device (such as antenna hardware) is a patch antenna including multiple patches interconnected via the electrically conductive path.

In further example embodiments, the flexible substrate is fabricated to include: i: non-bending portions (more rigid regions) that generally do not bend or less flexible, and ii) bending portions (less rigid or more flexible regions) that bend along bending lines or are more flexible. The different bend states of the flexible substrate include bending of the flexible substrate along respective bending lines of the flexible substrate.

Yet further example embodiments herein include an apparatus comprising a first antenna element, the first antenna element fabricated from electrically conductive material and including first material voids, the electrically conductive material being absent from the first material voids in the first antenna element; a transmission line coupled to the first antenna element; and the first material voids of the electrically conductive material of the first antenna element extending through the first antenna element.

In still further embodiments, the first antenna element is fabricated as a flexible mesh material disposed on a substrate. The first antenna element includes a first surface and a second surface. The first surface is disposed on an opposite facing with respect to the second surface of the first antenna element. In one embodiment, each of the first material voids in the flexible mesh material extend from the first surface through the first antenna element to the second surface.

In yet further example embodiments, the transmission line also includes second material voids extending through the transmission line. If desired, the first material voids in the one or more antenna elements on the flexible substrate and second material voids are filled with a non-electrically conductive material. Alternatively, the voids are filled with air, gas, vacuum, etc.

The transmission line disposed on the flexible substrate can be configured to include a first surface and a second surface. The second surface is disposed on an opposite facing of the transmission line with respect to the first surface. In one embodiment, each of the second material voids in the transmission line extend from the first surface through the transmission line to the second surface.

In further example embodiments, each of the one or more antenna elements (such as first antenna element, second antenna element, etc.) disposed on the flexible substrate is a patch antenna element. Such patch antenna elements are interconnected via circuit paths.

Further example embodiments herein include a second antenna element disposed on the flexible substrate. The wireless system further includes a circuit path extending and providing coupling between the first antenna element and the second antenna element.

In yet further example embodiments, as previously discussed, the transmission line fabricated on the flexible substrate includes second material voids extending through the transmission line. In one embodiment, the transmission line is fabricated as a mesh. Voids in the mesh patch antenna elements and/or transmission line can be filled with a non-electrically conductive material (such as insulator material).

In further example embodiments, each of the one or more antenna elements on the flexible substrate is operative to emit a wireless signal in a direction orthogonal to a surface of the first antenna element. The first material voids are disposed orthogonal to the surface of the first antenna element.

Further embodiments herein include substantially matching an impedance of the transmission line to an impedance of antenna hardware on the flexible substrate including the first antenna element connected to a second antenna element.

Further embodiments herein include a method comprising: fabricating a first antenna element. The first antenna element is fabricated from electrically conductive material and includes first material voids. The electrically conductive material is absent from the first material voids in the first antenna element. The first material voids of the electrically conductive material of the first antenna element extending through the first antenna element. The method further includes coupling a transmission line to the first antenna element.

Still further example embodiments herein include, via a fabricator, fabricating the first antenna element as a flexible mesh material disposed on a substrate (such as a flexible or rigid substrate).

In still further example embodiments, the first antenna element is fabricated to include a first surface and a second surface. The first surface is disposed on an opposite facing with respect to the second surface. In one embodiment, the fabricator fabricates each of the first material voids to extend from the first surface through the first antenna element to the second surface.

In yet further example embodiments, the fabricator fabricates the transmission line on to include second material voids extending through the transmission line. In one embodiment, one or more of the first material voids of the first antenna element and second material voids of the transmission line are filled with a non-electrically conductive material.

Still further example embodiments herein include, via the fabricator, fabricating the transmission line to include a first surface and a second surface. In one embodiment, the second surface is disposed on an opposite facing of the transmission line with respect to the first surface. The fabricator fabricates each of the second material voids in the transmission line to extend from the first surface through the transmission line to the second surface.

In yet further example embodiments, the fabricator fabricates the first antenna element to be a first patch antenna element such as on a rigid or flexible substrate.

Yet further example embodiments herein include, via the fabricator, fabricating a second antenna element on the flexible substrate; and fabricating a circuit path to extend between the first antenna element and the second antenna element. In one embodiment, the transmission line also fabricated on the substrate includes second material voids extending through the transmission line.

In further example embodiments, the fabricator fabricates the first antenna element to emit wireless signals or receive wireless signals in a direction orthogonal to a surface of the first antenna element. The fabricator disposes the first material voids in the one or more antenna elements to be orthogonal to the surface of the respective antenna element and corresponding flexible substrate on which the antenna element is mounted.

In a similar manner as previously discussed, the fabricator can be configured to fabricate an impedance of the transmission line to substantially match an impedance of antenna hardware including the first antenna element connected to a second antenna element, the fabrication of the transmission line takes into account flexibility of a corresponding substrate on which the antenna hardware (one or more antenna elements) is mounted.

Still further example embodiments include, via fabricator, a method comprising: receiving a flexible substrate; disposing a first circuit component on the flexible substrate, the first circuit component being a first antenna element, the first antenna element operative to transmit and receive first wireless signals; and disposing a second circuit component disposed on the substrate, the flexible substrate including one or more bend lines such as a first bend line disposed between the first circuit component and the second circuit component, the flexible substrate being bendable (such as hinged) with respect to the first bend line.

Still further example embodiments herein include, via the fabricator, executing one or more of the following operations: i) fabricating a first circuit path between the first circuit component and the second circuit component of a flexible antenna system; ii) defining a location of the first bend line of the flexible substrate based on a contour of a target object associated with the flexible substrate; iii) affixing the flexible substrate to a target object, the first bend line of the flexible antenna system (hardware) is aligned with an edge of a surface disposed on the target object; iv) fabricating a transmission line on the flexible substrate, an impedance of the transmission line substantially matching an impedance of antenna hardware including the first antenna element; v) fabricating a first portion of the transmission line on a first surface region of the flexible substrate on which the second circuit component is affixed; vi) fabricating a second portion of the transmission line on a second surface region of the flexible substrate on which the first circuit component is affixed, the first bend line disposed between the first surface region and the second surface region.

Yet further example embodiments herein include, via the fabricator, executing one or more of the following operations: i) coupling a transmission line to the first antenna element, the transmission line and the first antenna element disposed on a first surface region of the flexible substrate; ii) fabricating the second circuit component as a second antenna element on a second surface region of the flexible substrate, the second antenna element physically connected to the first antenna element via a first circuit path on the flexible substrate, the first bend line disposed between the first surface region and the second surface region; iii) fabricating the first bend line to be a first hinge-structure along which the flexible substrate bends; iv) fabricating a third circuit component on the flexible substrate, the third circuit component being a second antenna element, the second antenna element operative to transmit and receive second wireless signals; and connecting the second antenna element to the first antenna element via a circuit path disposed on the flexible substrate, the flexible substrate including a second bend line disposed between the first circuit component and the third circuit component, the flexible substrate bendable with respect to the second bend line; v) affixing the flexible substrate to a target object, the first bend line aligned with a first edge of a surface pattern disposed on the target object, the second bend line aligned with a second edge of the surface pattern disposed on the target device; vi) fabricating the first bend line to reside in a first region of the flexible substrate, the first region of the flexible substrate having a first flexibility; fabricating the flexible substrate to include a second region disposed adjacent to the first region; fabricating the flexible substrate to include a third region disposed adjacent to the first region, the first region disposed between the second region and the third region; and wherein the second region and the third region have a second flexibility different than the first flexibility.

Note further that any of the resources as discussed herein can include one or more computerized devices, controllers, wireless communication devices, gateway resources, mobile communication devices, sensors, servers, base stations, wireless communication equipment, communication management systems, controllers, workstations, user equipment, handheld or laptop computers, or the like to carry out and/or support any or all of the method operations disclosed herein. In other words, one or more computerized devices or processors can be programmed and/or configured to operate as explained herein to carry out the different embodiments as described herein.

Yet other embodiments herein include software programs to perform the steps and operations summarized above and disclosed in detail below. One such embodiment comprises a computer program product including a non-transitory computer-readable storage medium (i.e., any computer readable hardware storage medium) on which software instructions are encoded for subsequent execution. The instructions, when executed in a computerized device (hardware) having a processor, program and/or cause the processor (hardware) to perform the operations disclosed herein. Such arrangements are typically provided as software, code, instructions, and/or other data (e.g., data structures) arranged or encoded on a non-transitory computer readable storage medium such as an optical medium (e.g., CD-ROM), floppy disk, hard disk, memory stick, memory device, etc., or other a medium such as firmware in one or more ROM, RAM, PROM, etc., or as an Application Specific Integrated Circuit (ASIC), etc. The software or firmware or other such configurations can be installed onto a computerized device to cause the computerized device to perform the techniques explained herein.

Accordingly, embodiments herein are directed to a method, system, computer program product, etc., that supports operations as discussed herein.

One embodiment includes a computer readable storage medium and/or system having instructions stored thereon to support control according to embodiments herein. The instructions, when executed by the computer processor hardware, cause the computer processor hardware (such as one or more co-located or disparately processor devices or hardware) to: generate a model of a flexible substrate and corresponding radar sensor device disposed on the flexible substrate; analyze operation of the corresponding radar sensor device during different bend states of the flexible substrate in which the flexible substrate is bent to different non-planar states; and derive dimensions of an electrically conductive path (such as a transmission line) on the flexible substrate (antenna hardware, antenna system, etc.) based on the operation of the model during different states.

Another embodiment includes a computer readable storage medium and/or system having instructions stored thereon to support control according to embodiments herein. The instructions, when executed by the computer processor hardware, cause the computer processor hardware (such as one or more co-located or disparately processor devices or hardware) to: fabricate a first antenna element, the first antenna element fabricated from electrically conductive material and including first material voids, the electrically conductive material being absent from the first material voids in the first antenna element, the first material voids of the electrically conductive material of the first antenna element extending through the first antenna element; and couple a transmission line to the first antenna element.

Yet another embodiment includes a computer readable storage medium and/or system having instructions stored thereon to support control according to embodiments herein. The instructions, when executed by the computer processor hardware, cause the computer processor hardware (such as one or more co-located or disparately processor devices or hardware) to: receive a flexible substrate; dispose a first circuit component on the flexible substrate, the first circuit component being a first antenna element, the first antenna element operative to transmit and receive first wireless signals; and dispose a second circuit component disposed on the substrate, the flexible substrate including a first bend line disposed between the first circuit component and the second circuit component, the flexible substrate being bendable with respect to the first bend line.

The ordering of the steps above has been added for clarity sake. Note that any of the processing steps as discussed herein can be performed in any suitable order.

Other embodiments of the present disclosure include software programs and/or respective hardware to perform any of the method embodiment steps and operations summarized above and disclosed in detail below.

It is to be understood that the system, method, apparatus, instructions on computer readable storage media, etc., as discussed herein also can be embodied strictly as a software program, firmware, as a hybrid of software, hardware and/or firmware, or as hardware alone such as within a processor (hardware or software), or within an operating system or a within a software application.

As discussed herein, techniques herein are well suited for use in the field of conveying, transmitting, steering, analyzing, receiving, etc., wireless communications in wireless network environment. However, it should be noted that embodiments herein are not limited to use in such applications and that the techniques discussed herein are well suited for other applications as well.

Additionally, note that although each of the different features, techniques, configurations, etc., herein may be discussed in different places of this disclosure, it is intended, where suitable, that each of the concepts can optionally be executed independently of each other or in combination with each other. Accordingly, the one or more present inventions as described herein can be embodied and viewed in many different ways.

Also, note that this preliminary discussion of embodiments herein (BRIEF DESCRIPTION OF EMBODIMENTS) purposefully does not specify every embodiment and/or incrementally novel aspect of the present disclosure or claimed invention(s). Instead, this brief description only presents general embodiments and corresponding points of novelty over conventional techniques. For additional details and/or possible perspectives (permutations) of the invention(s), the reader is directed to the Detailed Description section (which is a summary of embodiments) and corresponding figures of the present disclosure as further discussed below.

### BRIEF DESCRIPTION OF THE DRAWINGS

FIG. 1 is an example diagram illustrating a wireless system according to embodiments herein.

FIG. 2 is an example diagram illustrating a side view of different layers of a flexible substrate in a planar (non-bent state) and corresponding components according to embodiments herein.

FIG. 3 is an example diagram illustrating a side view of different layers of a flexible substrate in a non-planar (bent state) and corresponding components according to embodiments herein.

FIG. 4 is an example diagram illustrating different target components on which to affix and operate a flexible wireless system according to embodiments herein.

FIG. 5 is an example diagram illustrating a top view of antenna hardware fabricated from a mesh structure according to embodiments herein.

FIG. 6A is an example more detailed diagram illustrating a top view of antenna hardware fabricated from a mesh structure according to embodiments herein.

FIG. 6B is an example more detailed diagram illustrating a side view of antenna hardware fabricated from a mesh structure according to embodiments herein.

FIG. 7A is an example graph illustrating return loss versus frequency for both a solid antenna hardware and mesh antenna hardware according to embodiments herein.

FIG. 7B is an example graph illustrating radiation efficiency versus frequency for both a solid antenna hardware and mesh antenna hardware according to embodiments herein.

FIGS. 8, 9, and 10 are example diagrams illustrating implementation of an antenna system on a flexible substrate and different bend states according to embodiments herein.

FIGS. 11A and 11B are example diagrams illustrating different bend states of a flexible substrate according to embodiments herein.

FIG. 12 is an example diagram illustrating analysis of a flexible substrate at different bending states to determine and define attributes of a transmission line suitable to support operation at the different possible bend states according to embodiments herein.

FIG. 13 is an example diagram illustrating a method of placing components on a circuit board based on bend lines according to embodiments herein.

FIG. 14 is an example diagram illustrating placement of components on a flexible substrate with respect to bend lines according to embodiments herein.

FIG. 15 is an example diagram illustrating example computer architecture operable to execute one or more operations according to embodiments herein.

FIGS. 16, 17, and 18 are example diagrams illustrating fabrication methods according to embodiments herein.

The foregoing and other objects, features, and advantages of the invention will be apparent from the following more particular description of preferred embodiments herein, as illustrated in the accompanying drawings in which like reference characters refer to the same parts throughout the different views. The drawings are not necessarily to scale, with emphasis instead being placed upon illustrating the embodiments, principles, concepts, etc.

### DETAILED DESCRIPTION

Embodiments herein implement flexible substrates (e.g. Polyimide or Liquid Crystal Polymer films or any other low-loss flexible substrates) to provide a novel free-form radar sensing system without degrading the performance. The thickness and the weight of the films are minuscule comparing to FR4 substrates, and the electrical properties are equivalent or superior to FR4 substrates. In one embodiment, to increase the efficiency and the flexibility of the radar sensor, the wire-mesh patch array is adapted. The traditional designing flows are also valid to the new flexible substrates.

The final radar sensing system can be flexible, conformal, free-form, stretchable and integrated into complex surfaces and structures. Also, depending on the type of the flexible substrate used, the bending characteristics can be altered from holding the shapes to continuously bending.

Improvements herein include the shape-manipulating abilities of the radar sensing systems. Moving the system from the rigid substrate to flexible substrate to make better use of the 3D world, break the barrier for flat circuit board design. Additionally, embodiments herein provide weight reduction. Allow for more light-weight and comfortable wearable devices.

Lastly, the easily integrated nature of the antenna system makes the proposed system integration friendly to complex mechanical structures. It can reduce the time and effort spending on designing specific structures to integrate the radar sensing system.

Embodiments herein can be implemented in different environments, leading to more compact radar sensing systems used on all kinds of scenarios, such as autonomous driving, health monitoring, traffic monitoring, personal tracking and so on. It can facilitate multiple system integration in existing forms. It can leverage the free-form nature to put several systems in an abnormal shell. It can result in foldable radar sensing system for wide-angle scanning and multiple-purpose beamforming.

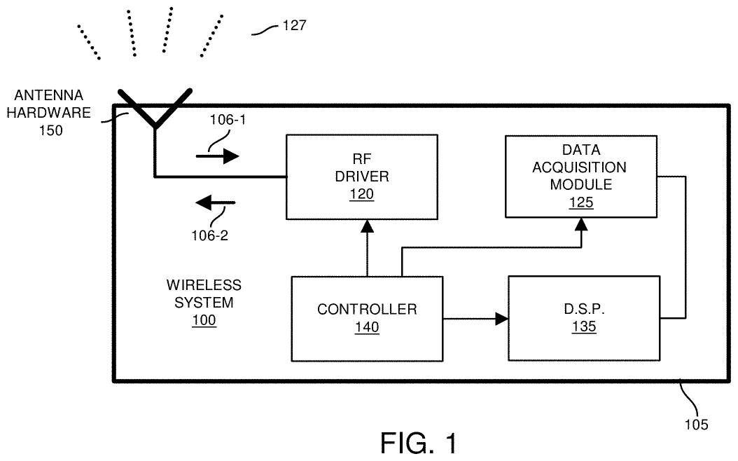

Now, more specifically, FIG. 1 is an example diagram illustrating a wireless system according to embodiments herein.

As shown, the wireless system 100 includes multiple components such as antenna hardware 150, RF driver 120, data acquisition module 125, controller 140, in digital signal processor 135.

As further discussed herein, the wireless system 100 is disposed on a flexible substrate 105. RF (Radio Frequency) driver 120 generates drive signal 106-1 to drive the antenna hardware 150 and emit wireless signals 127. In a reverse direction, the antenna hardware 150 receives wireless signals from other communication devices and produces signal 106-2 that is processed by respective circuit components on the flexible substrate 105.

In one embodiment, the wireless system 100 is implemented as a radar system detecting a distance from the wireless system 100 to one or more objects. For example, in one embodiment, the antenna hardware of the wireless system 100 generates one or more pings and determines a distance of a respective object off which the wireless signal from the antenna hardware 150 is reflected back to the antenna hardware 150 based on timing of transmitting the wireless signals and receiving the reflection signals.

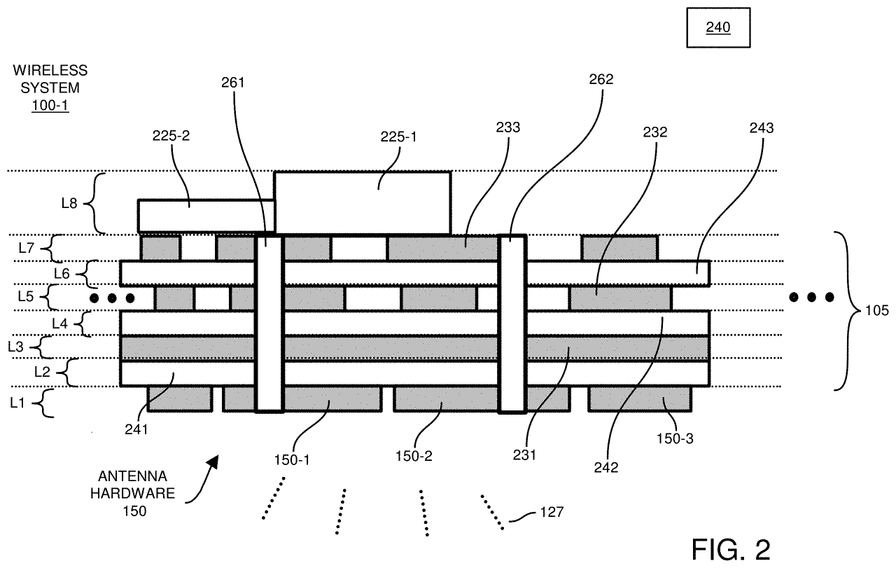

FIG. 2 is an example diagram illustrating a side view of different layers of a flexible substrate in a planar (non-bent state) and corresponding components according to embodiments herein.

This example embodiment illustrates a cross-section side view of a flexible radar system according to embodiments herein. By using one or more an ultra-thin substrate layers L2, L4, and L6 (such as ˜1 mil or other suitable thickness) and ultra-thin metal layers (such as ˜1 mil or other suitable thickness) for traces such as layers L1, L3, L5, and L7, the wireless system 100-1 is flexible and thin.

In one embodiment, each layer of the wireless system 100-1 supports a different material. For example, layer L1 includes antenna elements, one or more transmission line, electrically conductive paths, etc., associated with antenna hardware 150.

Layers L2, L4, and L6 (such as ultrathin film substrate material) are insulation layers (or spacers) such as fabricated from non-electrically conductive material.

Layers L3, L5, and L7 (such as ultrathin metal layer material) include electrically conductive material (such as circuit traces) providing circuit connectivity between antenna hardware and corresponding circuit components 209 such as fabricated from non-electrically conductive material.

More specifically, layer L1 includes antenna hardware 150 such as antenna element 150-1, antenna element 150-2, antenna element 150-3, etc. As previously discussed, layer L1 also includes electrically conductive paths connecting the antenna elements to each other. Additionally, the layer L1 includes one or more transmission lines in which to convey energy to and from the antenna hardware 150.

Layer L2 includes insulation layer 241 such as non-electrically conductive material (such as flexible insulation material).

Layer L3 includes one or more electrically conductive paths 231 providing respective connectivity between components in the wireless system 100-1.

Layer L4 includes insulation layer 242 such as non-electrically conductive material (such as flexible insulation material).

Layer L5 includes one or more electrically conductive paths 232 providing respective connectivity between components in the wireless system 100-1.

Layer L6 includes insulation layer 243 such as non-electrically conductive material (such as flexible insulation material).

Layer L7 includes one or more electrically conductive paths 233 providing respective connectivity between components in the wireless system 100-1.

Wireless system 100-1 further includes vias 261, 262, etc., providing connectivity between respective components.

Layer L8 includes one or more circuit components such as circuit component 225-1, circuit component 225-2, etc., (such as processor, circuits, etc.).

Note further that the wireless system 100-1 (such as sensor) can be bent at a large angle and conformal, has the ability for continuous bending. The board layout (flexible substrate 105) and IC packages (components 225) disposed in the wireless system 100-1 vary depending on the embodiment and support flexible as further discussed herein.

Thus, embodiments herein include an apparatus (wireless system 100-1) comprising: a flexible substrate 105; a radar sensor device (such as antenna hardware 150) disposed on the flexible substrate 105; and one or more electrically conductive paths (in layers L3, L5, and L7 communicatively coupled to the radar sensor device. The wireless system 100-1 includes integrated circuit chips such as components 225-1, 225-2, etc., connected to the radar sensor device (antenna hardware 150 such as antenna elements 150-1, 150-2, 150-3, transmission lines, electrically conductive paths, etc.) providing radar sensor functionalities. In one embodiment, the integrated circuit chips (such as components 225) are in contact with the flexible substrate 105 and corresponding electrically conductive paths in layers L3, L5, and L7. During operation, the wireless system 100-1 generates and receives wireless signals 127 during conditions in which the radar sensor device (antenna hardware 150) disposed on the flexible substrate 105 is bent to a non-planar state.

In one nonlimiting example embodiment, the antenna hardware 150 (such as radar sensor device) is a patch antenna system including multiple patches interconnected via electrically conductive paths in layer L1 or other layers. The dimensions and fabrication of the transmission lines and electrically conductive paths between patch antenna elements 150-1, 150-2, etc., facilitate operation of the antenna hardware and wireless system 100-1 (radar senor device) in the non-planar state.

As further discussed herein, the flexible substrate 105 is fabricated to include non-bending portions that do not bend or bend little and bending portions that bend along bending lines. The wireless system 100-1 includes an antenna interface (such as via component 225-2 or other suitable components) affixed to the substrate 105. The antenna interface receives and transmits signals over the electrically conductive paths.

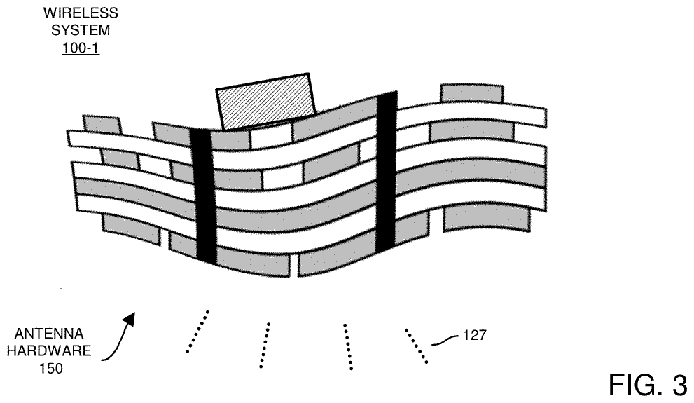

FIG. 3 is an example diagram illustrating a side view of different layers of a flexible substrate in a non-planar (bent state) and corresponding components according to embodiments herein.

In this example embodiment, the wireless system 100-1 transmits and receives wireless signals 127 while in a dynamically bent state.

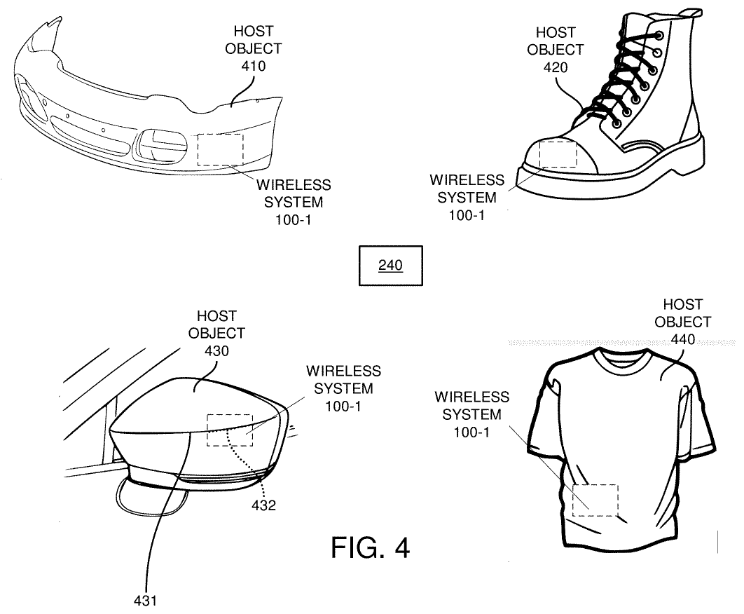

FIG. 4 is an example diagram illustrating different target components on which to affix and operate a flexible wireless system according to embodiments herein.

In this example embodiment, a respective instance of the wireless system 100-1 is installed, via fabricator 240, on one or more different objects.

For example, in one embodiment, the fabricator 240 installs (affixes) the wireless system 100-1 onto the host object 410 (such as a bumper of a car).

In accordance with another embodiment, the fabricator 240 installs (affixes) the wireless system 100-1 onto the host object 420 (such as a toe location of a boot). In accordance with another embodiment, the fabricator 240 installs (affixes) the wireless system 100-1 onto the host object 430 (such as a mirror of an automobile). In this example embodiment, the wireless system 100-1 includes a respective bend line 432. The wireless system 100-1 is affixed to the host object 430 such that the bend line 432 lines up with the edge 431.

In accordance with another embodiment, the fabricator 240 installs (affixes) the wireless system 100-1 onto the host object 440 (such as in the fabric of a shirt). In one embodiment, the entire flexible substrate bends.

In one embodiment, to avoid the performance degradation or malfunction of the radar system due to the change of impedance of RF traces and contacts of devices, some extra care can be implemented with respect to device (component) placement and traces routing according to the bending lines in the flexible substrate 105.

Note further that the flexible Printed Circuit Board (flexible substrate 105) has characteristics mostly implemented based on the material properties of ultra-thin film substrate layers. Different film can introduce different features. For the scenarios that the wireless system 100 is placed on dynamic surfaces like clothes, polyamide film or other suitable material can be used so that a repeated bending feature can be achieved. When integrated to a rigid irregular surface like bumper cover or rear view mirror on a car, LCP (liquid crystal polymer) film can be used to fabricate the wireless system 100 so that the wireless system and sensor will have a bend-and-hold feature to hold its final shapes.

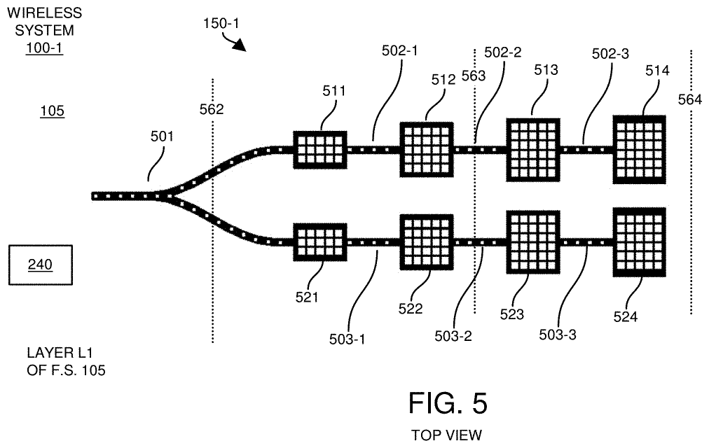

FIG. 5 is an example diagram illustrating a top view of antenna hardware fabricated from a mesh structure according to embodiments herein.

In this example embodiment, the fabricator 240 fabricates the antenna hardware 150-1 (such as an instance of the antenna hardware 150 in layer L1) onto a respective flexible substrate 105 in a manner as previously discussed.

In addition to fabricating the antenna hardware 150-1 onto the flexible substrate 105, the fabricator 240 fabricates the transmission line 501 onto the flexible substrate (layer L1). The transmission line 501 conveys energy to and from respective antenna hardware 150-1.

As shown, antenna hardware 150-1 includes patch antenna elements 511, 512, 513, and 514 interconnected via the electrically conductive paths 502-1, 502-2, 502-3, etc. Additionally, the antenna hardware 150-1 includes patch antenna elements 521, 522, 523, and 524 interconnected via the electrically conductive paths 503-1, 503-2, 503-3, etc.

In one embodiment, as shown, the transmission line 501, electrically conductive paths 502, electrically conductive paths 503, and corresponding patch antenna elements associated with antenna hardware 150-1 are fabricated as mesh to include material voids and material non-voids as further discussed herein. Additional details are discussed in the following FIGS and corresponding text.

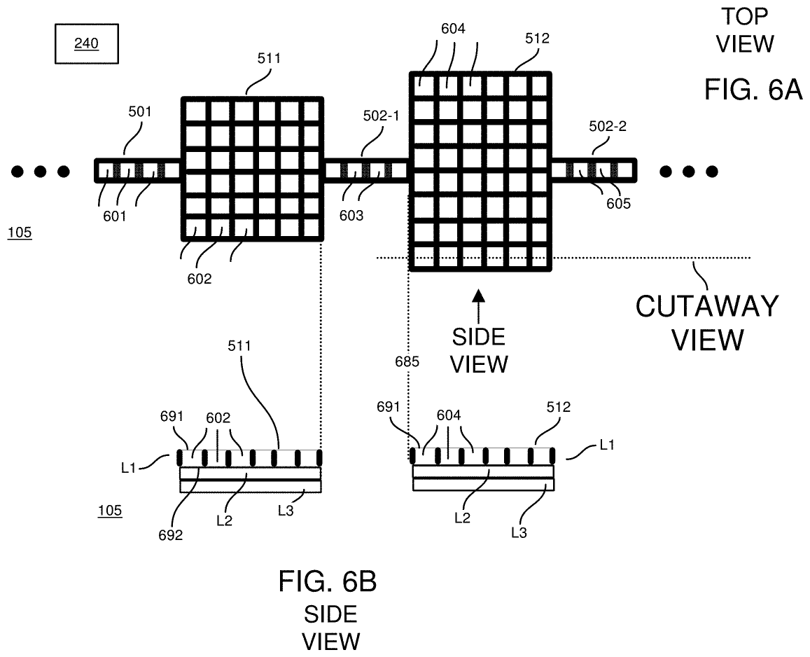

FIG. 6A is an example more detailed diagram illustrating a top view of antenna hardware fabricated from a mesh structure according to embodiments herein.

The fabricator 240 fabricates the wireless system 100-1 to includes patch antenna elements 511, 512, etc., as well as transmission line 501, and electrically conductive paths 502, 503.

FIG. 6B is an example more detailed diagram illustrating a side view of antenna hardware fabricated from a mesh structure according to embodiments herein.

In this example embodiment, the fabricator 240 fabricates a first antenna element 511 onto a substrate such as flexible substrate 105. The first antenna element 511 is fabricated from electrically conductive material (such as one or more different types of metal) and includes first material voids 602 (i.e., volumes where the electrically conductive material does not reside).

More specifically, in one embodiment, the electrically conductive material used to fabricate the patch antenna element 511 is absent from the first material voids 602 (such as holes, openings, paths, etc.) in the first antenna element 511. In one embodiment, the first material voids 602 of the electrically conductive material of the first antenna element 511 extend through the first antenna element 511 from surface 691 to surface 692. The fabricator 240 fabricates and couples a transmission line 501 to the first antenna element 511 and patch antenna element 521.

In one embodiment, the fabricator 240 fabricates the first antenna element 511 as a flexible mesh material disposed on a flexible substrate 105.

In further example embodiments, the fabricator 240 fabricates the first antenna element 511 to include a first surface 691 and a second surface 692; the first surface 691 is disposed on an opposite facing of the antenna element 511 with respect to the second surface 692. The fabricator 240 fabricates each of the first material voids 602 to extend from the first surface 691 through the first antenna element 511 to the second surface 692.

In further example embodiments, the fabricator 240 fabricates the transmission line 501 to include respective material voids 601 extending through the transmission line 501. In one embodiment, the fabricator 240 fabricates each of the first material voids 601 to extend from the first surface 691 through the transmission line 501 to the second surface 692.

The fabricator 240 fabricates each of the electrically conductive paths 502-1, 502-2, etc., to include respective material voids 603, 605, etc., extending through the electrically conductive paths 502.

In one nonlimiting example embodiment, the fabricator 240 fabricates one or more of the material voids 601, material voids 602, material voids 603, material voids 604, material voids 605, etc., with non-electrically conductive material. Alternatively, one or more of these material voids are filled with gas, air, vacuum, etc.

In further example embodiments, as previously discussed, the fabricator fabricates the transmission line 501 to include a first surface 691 and a second surface 692. The second surface 692 is disposed on an opposite facing of the transmission line 501 with respect to the first surface 691. The fabricator 240 fabricates each of the material voids 601 in the transmission line 501 to extend from the first surface 691 through the transmission line 501 to the second surface 692.

As previously discussed, in one embodiment, each of the antenna elements 511, 512, etc., is a patch antenna element fabricated on the respective flexible substrate 105. The fabricator 240 fabricates a second antenna element 512 on the flexible substrate 105. The fabricator 240 fabricates an electrically conductive path 502-1 (circuit path) on the flexible substrate 105 to extend between the first antenna element 511 and the second antenna element 512. As previously discussed, the fabricator 240 can be configured to fabricate the transmission line 501 and one or more electrically conductive paths 502 to include material voids extending through the transmission line 501 and electrically conductive paths 502.

In further example embodiments, the fabricator 240 fabricates the first antenna element 511, 512, etc., to emit wireless signals in a direction orthogonal (such as parallel to axis 685) to a surface 691 of the antenna elements. The fabricator 240 disposes the material voids 602 to be orthogonal (such as parallel to axis 685) to the surface 691 of the first antenna element.

In further example embodiments, the fabricator 240 fabricates an impedance of the transmission line 501 to substantially match an impedance of antenna hardware 150 including the antenna elements 511, 512, 513, etc.

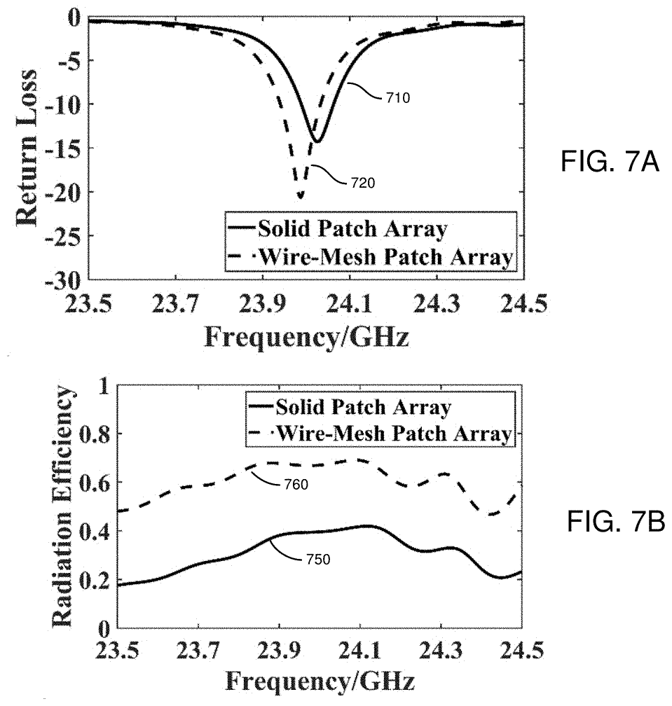

FIG. 7A is an example graph illustrating return loss versus frequency for a solid antenna hardware and mesh antenna hardware according to embodiments herein.

Due to the ultra-thin nature of the flexible substrate 105, the radiation efficiency of the antenna hardware 150 may be hindered by the dielectric loss from the substrate as well as metal losses, resulting in low RF radiation power and thermal problems. To enhance the performance of the RF parts, embodiments herein include implementing the antenna hardware 150 to include wire-mesh patch arrays (such as FIGS. 6A and 6B) in a manner as previously discussed.

As shown in FIG. 7A, both the feeding trace (such as transmission line 501) and the patch antenna elements (511, 512, etc.) are made of metal wire mesh rather than solid metal sheets. In one embodiment, the size of the hollow or filled area (material voids) is electrically small (substantially smaller) compared to the wavelength generating wireless signals 127 received and/or transmitted from the antenna hardware 150, indicating the RF performance will not be affected. Compared with the solid metal sheet, this wire-mesh geometry of patch antenna elements as discussed herein significantly decreases the non-necessary area of the antenna, leading to high efficiency. Return loss 720 over a range of frequencies for the mesh patch antenna elements is better than the return loss 710 over the range of frequencies for the conventional solid patch antenna elements.

The comparisons of the simulation results of the solid and wire-mesh patch antenna array shown in FIG. 7A indicate that the wire-mesh antenna array achieves better impedance matching.

FIG. 7B is an example graph illustrating radiation efficiency versus frequency for both a solid antenna hardware and mesh antenna hardware according to embodiments herein.

Additionally, as presented in FIG. 7B, the wire-mesh antenna array provides higher radiation efficiency (20% or higher) compared with the solid patch array. For example, the radiation efficiency 760 over a range of frequencies for the mesh patch antenna elements is better than the radiation efficiency 750 over the range of frequencies for the conventional solid patch antenna elements. Furthermore, because of the hollow area generated by the wire-mesh structure for patch antenna elements, transmission line, and electrically conductive paths, the radar sensor's flexibility is significantly enhanced.

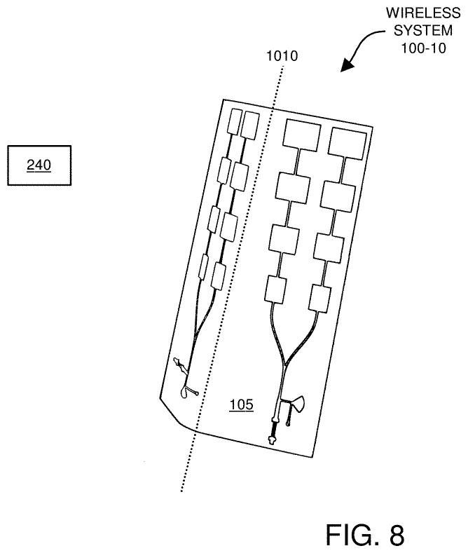

FIGS. 8, 9, and 10 are example diagrams illustrating different flex positions of a flexible substrate according to embodiments herein.

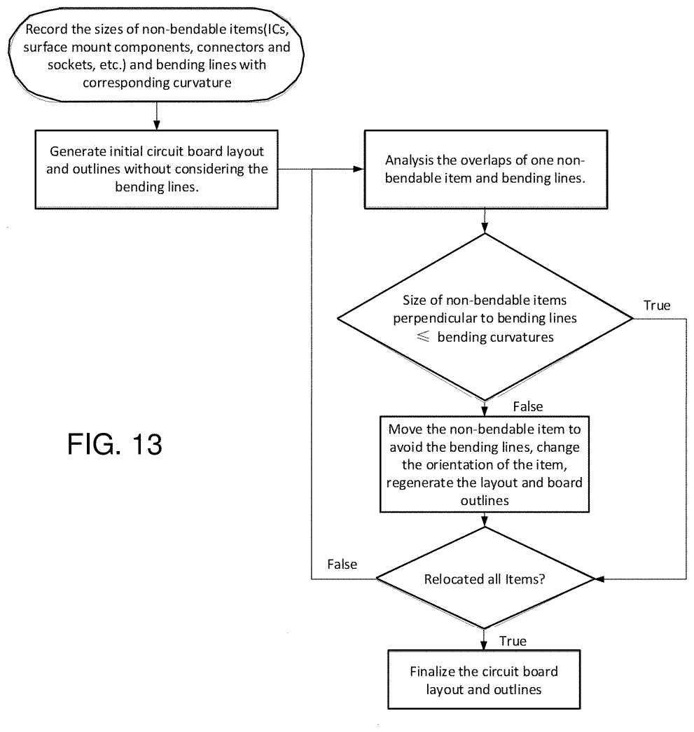

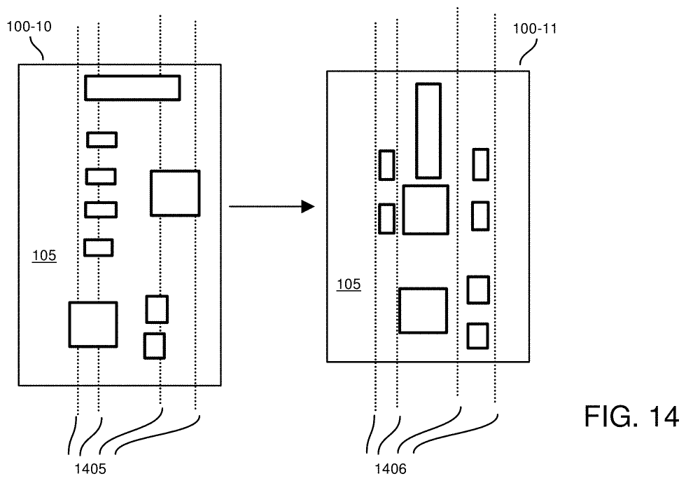

Embodiments herein include a method for generating optimized circuit board layouts to cope with bending lines involving the non-bendable items. As previously discussed, apart from the previously mentioned planar antennas, the radar system also requires integrated chips (ICs) and companioned passive components (capacitors, resistors, inductors, etc.), as well as connectors and sockets to communicate with external controllers or computation units. Since such items are always packaged in rigid bodies, the overlaps of such items and bending lines will cause trouble during the actual bending states. To solve this problem, the flowchart in FIG. 13 is used to determine if non-bendable items on PCB will affect the bending lines, and if so, the violated items should be relocated and/or rotated. After modifying and checking for all the non-bendable items used for designing the PCB, an updated layout and board outline can be obtained to fully compatible with all bending lines and curvatures. FIG. 14 shows an example for the PCB layout changes using the method mentioned in FIG. 13 to be compatible with bending lines.

In this example embodiment of FIG. 8, the wireless system 100-10 includes a substrate 105 that has a same flexibility (such as homogeneous flexibility) throughout the different regions of the substrate 105. Accordingly, the wireless system 100-10 bends along axis 1010 and any other axis of the wireless system 100-10.

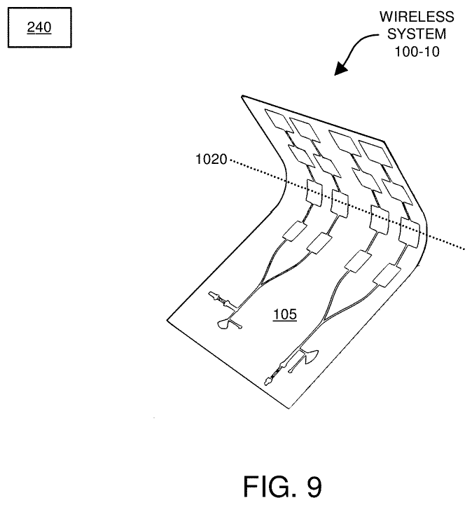

In FIG. 9, the wireless system 100-10 bends with respect to axis 1020. The components such as antenna elements, connective paths, etc., disposed on the surface of the substrate 105 also bend with respect to the axis 1030.

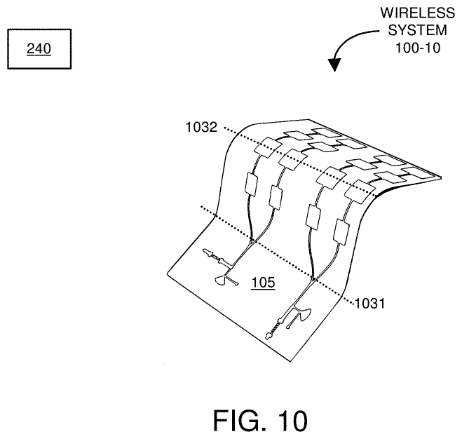

In FIG. 10, the wireless system 100-10 and corresponding substrate 105 bends with respect to other axes such as axis 1031 and axis 1032.

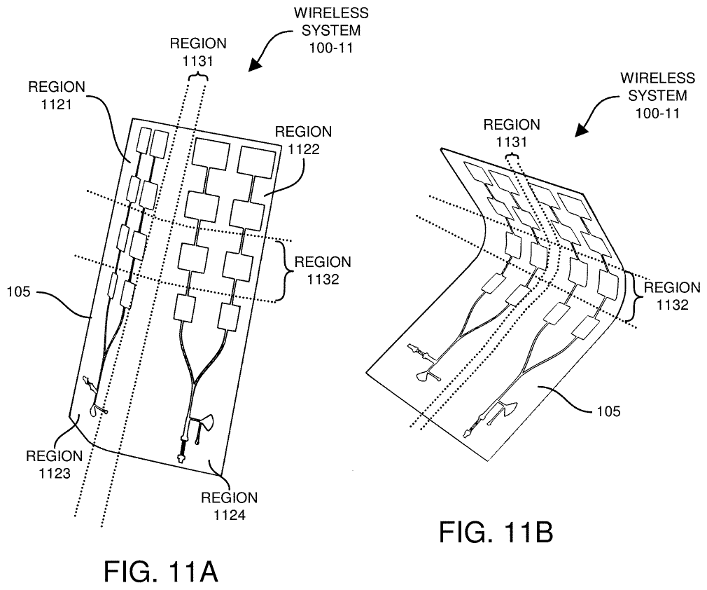

FIGS. 11A and 11B are example diagrams illustrating implementation of a flexible substrate having different flexibilities in different regions according to embodiments herein.

As previously discussed, in certain embodiments, it is desirable that some regions of the respective substrate 105 are more rigid than other regions of the flexible substrate 105. For example, in the embodiment of FIG. 11A, the wireless system 100-11 includes the components as previously discussed. However, the wireless system 100-11 includes a substrate 105 that has a different flexibility throughout the different regions of the substrate 105.

More specifically, in this example embodiment, the portions of the flexible substrate 105 in regions 1131 and 1132 are more flexible than regions 1121, 1122, 1123, and 1124. In such an instance, the substrate 105 and corresponding wireless system 100-11 bends along region 1131 (such as an axis or region depending on how wide) as shown in FIG. 11A.

Further in this example embodiment, as shown in FIG. 11B, because the portions of the flexible substrate 105 in regions 1131 and 1132 are more flexible than regions 1121, 1122, 1123, and 1124, the substrate 105 and corresponding wireless system 100-11 bends along region 1132 (such as an axis or region depending on how wide) as shown in FIG. 11A.

Further example embodiments herein include, via the fabricator 240, receiving or producing the flexible substrate 105; disposing a first circuit component on the flexible substrate 105, the first circuit component being a first antenna element 511, the first antenna element operative to transmit and receive first wireless signals 127; and disposing a second circuit component (such as antenna element 512) on the flexible substrate 105, the flexible substrate 105 including a first bend line 563 or bend region disposed between the first circuit component and the second circuit component, the flexible substrate being bendable with respect to the first bend line 563.

The fabricator 240 further performs one or more of the following operations: i) fabricating a first circuit path (such as electrically conductive path 502-1) between the first circuit component (antenna element 511) and the second circuit component (antenna element 512); ii) defining a location of the first bend line 563 of the flexible substrate 105 based on a contour of a target object (see FIG. 4, bend line 432 resides on contour of object 430 and corresponding edge 431) associated with the flexible substrate 105; iii) affixing the flexible substrate 105 to a target object 430, the first bend line 432 aligned with an edge 431 of a surface disposed on the target object 430; iv) fabricating a transmission line 501 on the flexible substrate 105, an impedance of the transmission line 105 substantially matching an impedance of antenna hardware 150 including the first antenna element 511 and second antenna element 512; v) fabricating a first portion of the transmission line 501 on a first surface region of the flexible substrate 105 on which the second circuit component is affixed; and fabricating a second portion of the transmission line 511 on a second surface region of the flexible substrate 105 on which the first circuit component is affixed, the first surface region and the second surface region divided by the bend line 562 of the flexible substrate 105; vi) coupling a transmission line 501 to the first antenna element 511, the transmission line 501 and the first antenna element 511 disposed on a first surface region of the flexible substrate 105; and fabricating the second circuit component as a second antenna element 512 on a second surface region of the flexible substrate 105, the second antenna element 512 physically connected to the first antenna element 511 via electrically conductive path 502-1 on the flexible substrate 105, the bend line 563 disposed between the first surface region and the second surface region; wherein the first bend line 563 is a hinge along which the flexible substrate 105 bends.

As previously discussed, embodiments herein include, via the fabricator 240, affixing the flexible substrate 105 to a target object 430 (see FIG. 4), the bend line 432 of the wireless system 100-1 aligned with a first edge 431 of a surface pattern disposed on the target object 430. In one embodiment, the wireless system 100-1 includes a second bend line aligned with a second edge of a respective surface pattern disposed on the target device.

In yet further example embodiments, the fabricator 240 fabricates the first bend line to reside in a first region of the flexible substrate, the first region of the flexible substrate having a first flexibility; fabricating the flexible substrate to include a second region disposed adjacent to the first region; fabricating the flexible substrate to include a third region disposed adjacent to the first region, the first region disposed between the second region and the third region; and wherein the second region and the third region have a second flexibility different than the first flexibility.

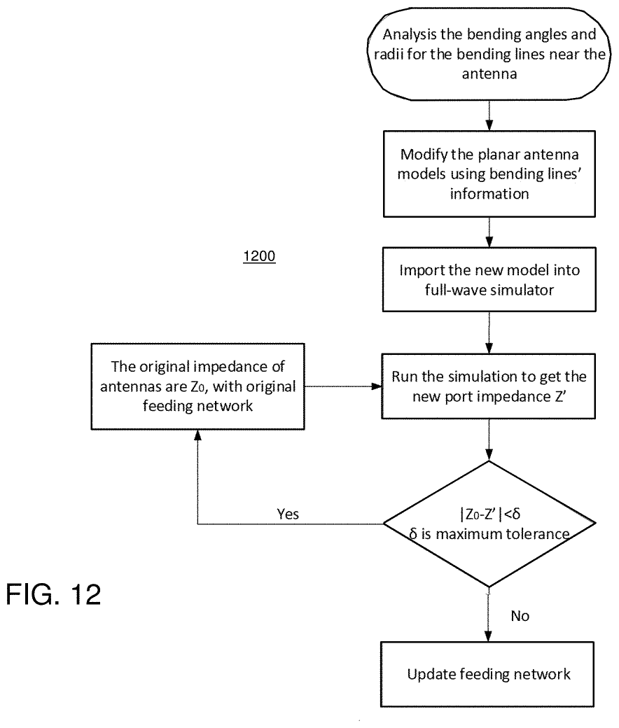

FIG. 12 is an example diagram illustrating flowchart of determining dimension of a respective transmission line based on different possible bend states according to embodiments herein.

As previously discussed, FIGS. 8, 9, 10 and 11 illustrate different bending states for the antenna h 150 and flexible substrate 105. In one embodiment, the antenna hardware 150 is chosen to show how the different bending states will impact the intrinsic impedance of RF circuits. And the antenna, due to its large area, is the most susceptible to such changes. Depending on the bending angle and radius, all RF traces (transmission lines) and some of the high-speed digital buses are also susceptible to changes induced by bending.

Embodiments herein include a method comprising: generating a model of a flexible substrate and corresponding radar sensor device disposed on the flexible substrate; analyzing operation of the corresponding radar sensor device during different bend states of the flexible substrate in which the flexible substrate is bent to different non-planar states; and deriving dimensions of an electrically conductive path on the flexible substrate based on the operation of the model during different states.

In one embodiment, the fabricator derives the dimensions of the electrically conductive path via controlling dimensions of the electrically conductive paths or transmission line to account for bending of the flexible substrate to the different non-planar states. This can include adjusting an impedance of the electrically conductive path s and transmission line to account for bending of the flexible substrate 105.

As previously discussed, the flexible substrate is fabricated to include non-bending portions that do not bend and bending portions that bend along bending lines; the different bend states of the flexible substrate include bending of the flexible substrate along respective bending lines of the flexible substrate.

FIG. 8 shows an example flowchart to update the feeding network subject to different bending states caused by the different target surfaces, where the Radar sensor system will be integrated. As described before, only high-frequency circuits and high-speed digital circuits are most vulnerable when bending, the updated regions can be limited to those parts of the whole circuit to reduce the complexity of the analysis. FIG. 8 considers the bending around the flexible antenna on the whole flexible circuit board, and the bending models can be generated in the same method of FIG. 7. An updated feeding network generated by the flowchart can be guaranteed to work with the specific bending states.

FIG. 13 is an example diagram illustrating a method of determining placement of components on a flexible substrate based on bend lines according to embodiments herein.

FIG. 14 is an example diagram illustrating placement of components in non-bending regions of a flexible substrate such as via implementation of the method 1300 according to embodiments herein.

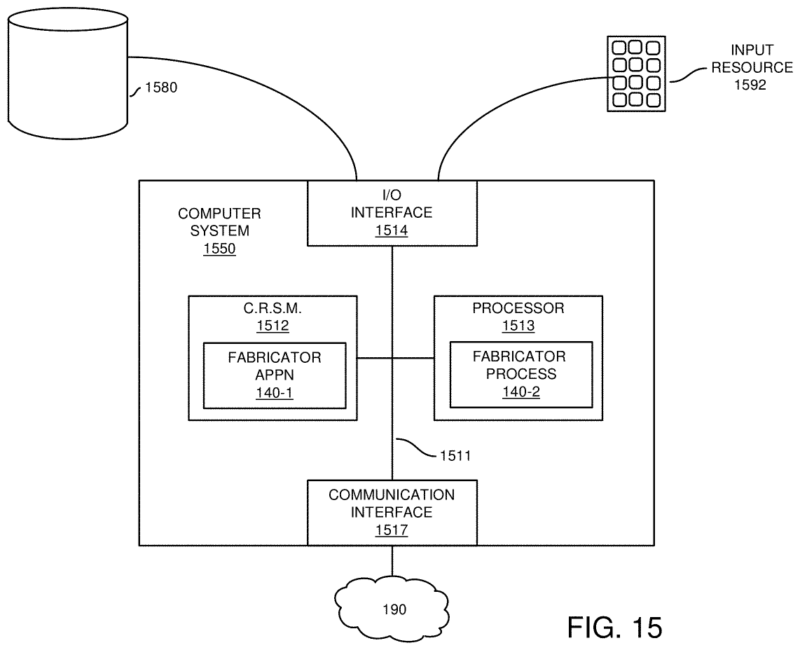

FIG. 15 is an example block diagram of a computer system for implementing any of the operations as previously discussed according to embodiments herein.

Any of the resources (such as controller 140, etc.) as discussed herein can be configured to include computer processor hardware and/or corresponding executable (software) instructions to carry out the different operations as discussed herein.

As shown, computer system 1550 of the present example includes an interconnect 1511 coupling computer readable storage media 1513 such as a non-transitory type of media (which can be any suitable type of hardware storage medium in which digital information can be stored and retrieved), a processor 1513 (computer processor hardware), I/O interface 1514, and a communications interface 1517.

I/O interface(s) 1514 supports connectivity to repository 1580 and input resource 1592.

Computer readable storage medium 1512 can be any hardware storage device such as memory, optical storage, hard drive, floppy disk, etc. In one embodiment, the computer readable storage medium 1512 stores instructions and/or data.

As shown, computer readable storage media 1512 can be encoded with management application 140-1 (e.g., including instructions) to carry out any of the operations as discussed herein.

During operation of one embodiment, processor 1513 accesses computer readable storage media 1512 via the use of interconnect 1511 in order to launch, run, execute, interpret or otherwise perform the instructions in in the management application 140-1 stored on computer readable storage medium 1512. Execution of the control application 140-1 produces control process 140-2 to carry out any of the operations and/or processes as discussed herein.

Those skilled in the art will understand that the computer system 1550 can include other processes and/or software and hardware components, such as an operating system that controls allocation and use of hardware resources to execute management application 140-1.

In accordance with different embodiments, note that computer system may reside in any of various types of devices, including, but not limited to, a mobile computer, wireless communication device, gateway resource, communication management resource, a personal computer system, a wireless device, a wireless access point, a base station, phone device, desktop computer, laptop, notebook, netbook computer, mainframe computer system, handheld computer, workstation, network computer, application server, storage device, a consumer electronics device such as a camera, camcorder, set top box, mobile device, video game console, handheld video game device, a peripheral device such as a switch, modem, router, set-top box, content management device, handheld remote control device, any type of computing or electronic device, etc. The computer system 850 may reside at any location or can be included in any suitable resource in any network environment to implement functionality as discussed herein.

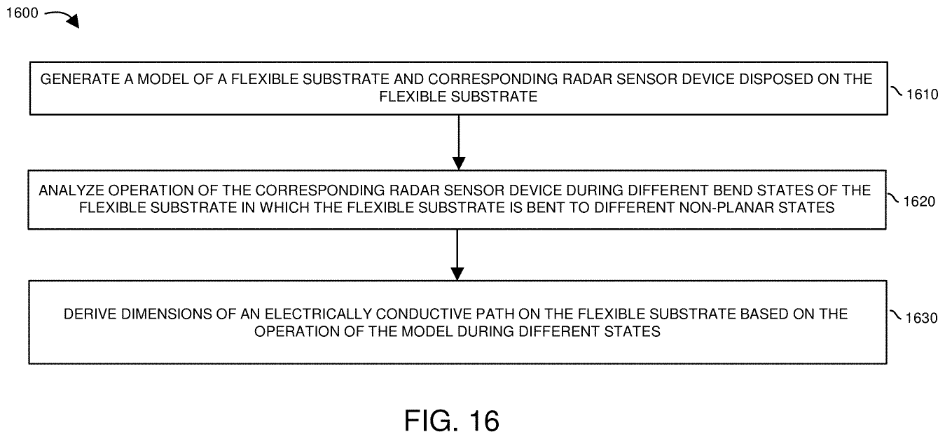

Functionality supported by the different resources will now be discussed via flowchart in FIGS. 16-18. Note that the steps in the flowcharts below can be executed in any suitable order.

FIG. 16 is a flowchart 1600 illustrating an example method according to embodiments herein. Note that there will be some overlap with respect to concepts as discussed above.

In processing operation 1610, the fabricator 240 generates a model of a flexible substrate 105 and corresponding radar sensor device (antenna hardware 150, transmission line, etc.) disposed on the flexible substrate 105.

In processing operation 1620, the fabricator 240 analyzes operation of the corresponding radar sensor device (antenna hardware and corresponding components) during different bend states of the flexible substrate in which the flexible substrate is bent to different non-planar states.

In processing operation 1630, the fabricator 240 derives dimensions of one or more electrically conductive paths (such as transmission line) on the flexible substrate 105 based on the operation of the model during different states.

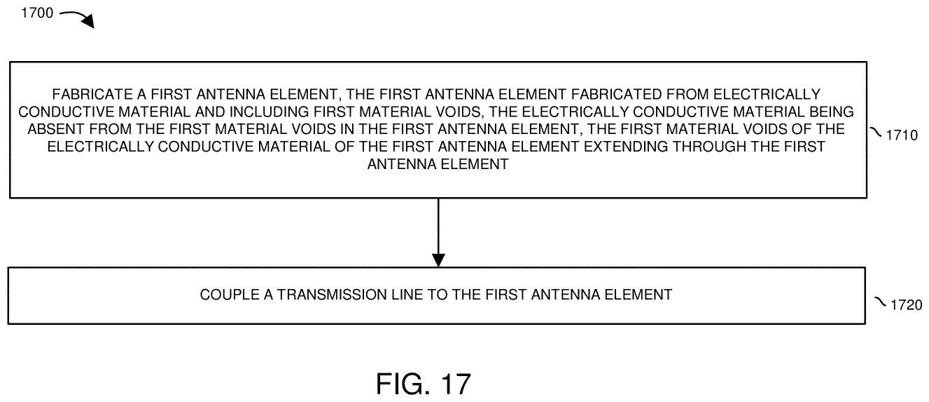

FIG. 17 is a flowchart 1700 illustrating an example method according to embodiments herein. Note that there will be some overlap with respect to concepts as discussed above.

In processing operation 1710, the fabricator 240 fabricates a first antenna element, the first antenna element fabricated from electrically conductive material and including first material voids, the electrically conductive material being absent from the first material voids in the first antenna element, the first material voids of the electrically conductive material of the first antenna element extending through the first antenna element.

In processing operation 1720, the fabricator couples a transmission line to the first antenna element.

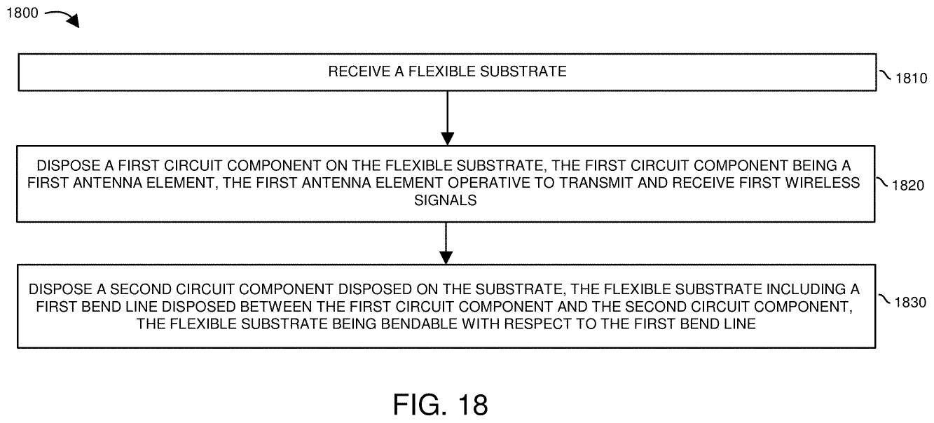

FIG. 18 is a flowchart 1800 illustrating an example method according to embodiments herein. Note that there will be some overlap with respect to concepts as discussed above.

In processing operation 1810, the fabricator 240 fabricates and/or receives a flexible substrate 105.

In processing operation 1820, the fabricator 240 disposes a first circuit component on the flexible substrate 105. The first circuit component being a first antenna element, the first antenna element operative to transmit and receive first wireless signals.

In processing operation 1830, dispose a second circuit component disposed on the substrate, the flexible substrate including a first bend line disposed between the first circuit component and the second circuit component, the flexible substrate being bendable with respect to the first bend line.

Note again that techniques as discussed herein are well suited for use in applications supporting wireless communications via a wireless system disposed on a flexible substrate. However, it should be noted that embodiments herein are not limited to use in such applications and that the techniques discussed herein are well suited for other applications as well.

Based on the description set forth herein, numerous specific details have been set forth to provide a thorough understanding of claimed subject matter. However, it will be understood by those skilled in the art that claimed subject matter may be practiced without these specific details. In other instances, methods, apparatuses, systems, etc., that would be known by one of ordinary skill have not been described in detail so as not to obscure claimed subject matter. Some portions of the detailed description have been presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm as described herein, and generally, is considered to be a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has been convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels.

While this invention has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting. Rather, any limitations to the invention are presented in the following claims.

1. An apparatus comprising:
a flexible substrate;
a radar sensor device disposed on the flexible substrate; and
an electrically conductive path communicatively coupled to the radar sensor device, with integrated circuit chips connected to the radar sensor device providing radar sensor functionalities, the integrated circuit chips being in contact with the flexible substrate and the electrically conductive path, the radar sensor device operative to generate and receive wireless signals during conditions in which the radar sensor device disposed on the flexible substrate is bent to a non-planar state.

2. The apparatus as in claim 1, wherein the radar sensor device includes a patch antenna array with multiple patches interconnected via the electrically conductive path.

3. The apparatus as in claim 1, wherein dimensions and fabrication of the electrically conductive path facilitate operation of the radar sensor device in the non-planar state.

4. The apparatus as in claim 1, wherein the flexible substrate is fabricated to include free bending portions that do not bend and bending portions that bend along bending lines.

5. The apparatus as in claim 1 further comprising:
an antenna interface affixed to the substrate, the antenna interface operative to receive and transmit signals over the electrically conductive path.

6. A method comprising:
generating a model of a flexible substrate and corresponding radar sensor device disposed on the flexible substrate;
analyzing operation of the corresponding radar sensor device during different bend states of the flexible substrate in which the flexible substrate is bent to different non-planar states; and
deriving dimensions of an electrically conductive path on the flexible substrate based on the operation of the model during different states.

7. The method as in claim 6, wherein deriving the dimensions of the electrically conductive path includes:
controlling dimensions of the electrically conductive path to account for bending of the flexible substrate to the different non-planar states.

8. The method as in claim 6, wherein deriving the dimensions of the electrically conductive path includes: adjusting an impedance of the electrically conductive path.

9. The method as in claim 6, wherein the radar sensor device is a patch antenna including multiple patches interconnected via the electrically conductive path.

10. The method as in claim 6, wherein the flexible substrate is fabricated to include free bending portions that do not bend and bending portions that bend along bending lines; and
wherein the different bend states of the flexible substrate include bending of the flexible substrate along respective bending lines of the flexible substrate.

11. An apparatus comprising:
a first antenna element, the first antenna element fabricated from electrically conductive material and including first material voids, the electrically conductive material being absent from the first material voids in the first antenna element;
a transmission line coupled to the first antenna element; and
the first material voids of the electrically conductive material of the first antenna element extending through the first antenna element.

12. The apparatus as in claim 11, wherein the first antenna element is fabricated as a flexible mesh material disposed on a substrate.

13. The apparatus as in claim 11, wherein the first antenna element includes a first surface and a second surface, the first surface disposed on an opposite facing with respect to the second surface, each of the first material voids extending from the first surface through the first antenna element to the second surface.

14. The apparatus as in claim 11, wherein the transmission line includes second material voids extending through the transmission line; and
wherein the first material voids and second material voids are filled with a non-electrically conductive material.

15. The apparatus as in claim 14, wherein the transmission line includes a first surface and a second surface, the second surface disposed on an opposite facing of the transmission line with respect to the first surface, each of the second material voids in the transmission line extending from the first surface through the transmission line to the second surface.

16. (canceled)

17. The apparatus as in claim 11 further comprising:
a flexible substrate on which the first antenna element are fabricated.

18. The apparatus as in claim 17 further comprising:
a second antenna element disposed on the flexible substrate; and
a circuit path extending between the first antenna element and the second antenna element.

19. The apparatus as in claim 18, wherein the transmission line includes second material voids extending through the transmission line.

20. The apparatus as in claim 11, wherein the first antenna element is operative to emit a wireless signal in a direction orthogonal to a surface of the first antenna element; and
wherein the first material voids are disposed orthogonal to the surface of the first antenna element.

21. The apparatus as in claim 11, wherein an impedance of the transmission line substantially matches an impedance of antenna hardware including the first antenna element connected to a second antenna element.

22-55. (canceled)
